(19) United States
(12) Patent Application Publication
(10) Pub. No.: US 2014/0160169 A1
(43) Pub. Date: Jun. 12, 2014

(54) IMAGE PROCESSING APPARATUS AND IMAGE PROCESSING METHOD

(71) Applicant: Eisaku Ishii, Tokyo (JP)

(72) Inventor: Eisaku Ishii, Tokyo (JP)

(73) Assignee: NEC Display Solutions, Ltd., Tokyo (JP)

(21) Appl. No.: 14/233,382

(22) PCT Filed: Aug. 18, 2011
(86) PCT No.: PCT/JP2011/068661

§ 371 Date: Jan. 16, 2014

(51) Int. Cl. G06T 3/00; G06T 5/00

(52) U.S. Cl. CPC G06T 3/005; G06T 5/006
USPC 345/672

(57) ABSTRACT

The object of the present invention is to correct an image in response to a distortion of the shape of pixels on a projection surface. An image processing apparatus includes: a display element having a plurality of pixels to display an image based on image data; a projection optical system projecting the image displayed on the display element onto a projection surface; a transformer that, after receiving a correction parameter for changing the shape of the projected image in order to correct distortion of the projected image, performs coordinate transformation of each pixel of a source image represented by the image data, using the correction parameter, and outputs the result of coordinate transformation, which provides the coordinates of each pixel of the resultant output image that correspond to the coordinates of each pixel of the source image; and, a processor that determines the pixel value of every pixel of the output image in accordance with the ratio of the pixels of the source image in each pixel of the output image represented by the result of coordinate transformation.

### TECHNICAL FIELD

The present invention relates to an image processing apparatus and an image processing method, in particular relating to an image processing apparatus and an image processing method for correcting distortion of a projected image.

### BACKGROUND ART

Recently, projectors that enlarge and project an image onto a projection surface have been often used as a display apparatus for making presentations. A projector is usually designed to form a projected image similar to a source image when the apparatus is placed perpendicular to the projection surface.

However, there are cases where it is difficult to set the projector be perpendicular to the screen or to the projection surface. It is also assumed that when a projector is used for advertisement purposes and the like, the image is enlarged and projected on a round column or a spherical surface. When the projector is used under such circumstances, the image on the projection surface becomes distorted. This distortion on the image on the projection surface arises due to the geometric relationship such as the spatial positional relationship between the projection surface and the projector, the spatial positional relationship between the projection surface and the position of the user's viewpoint and the magnifying power of the projection lens, the shape of the projection surface and the like, hence is called geometric distortion.

In a projector, by displaying a corrected image that has been changed in shape beforehand in order to cancel out geometric distortion, it is possible to project an image free from distortion when the user views the projected image from their viewpoint.

For example, Patent Document 1 discloses a projector which corrects geometric distortion that would occur when an image is projected obliquely to a flat screen. This projector receives two tilt angles in a horizontal direction and in a vertical direction relative to the flat screen and determines transformation parameters for performing perspective transformation (mapping transformation) using the tilt angles in the two directions. Based on the transformation parameters, the source image is transformed into a corrected image that will make the projected image free from distortion when viewed from the viewpoint.

Patent Document 2 discloses a projector which corrects distortion that arises when an image is projected on to a spherical dome screen. Because the projection surface is spherical, this projector determines the corrected image by carrying out coordinate transformation in polar coordinates and orthogonal coordinates.

In order to determine a corrected image using coordinate transformation, it is necessary to determine a coordinate transformation formula for transforming the image from the coordinate system on the projection surface viewed from the viewpoint to the coordinate system on the display element and its inverse transformation formula. The coordinate transformation formula and inverse transformation formula can be determined using the shape of the projection surface, the positional relationship between the projection surface and the projector, the positional relationship between the projection surface and the position of viewpoint and information on the magnifying power of the projecting lens and the like. For example, a coordinate transformation formula for correcting geometric distortion that arises on a flat screen is given in Patent Document 1.

For example, when the coordinate system on the projection surface is given as (u, v) and the coordinate system on the display element is given as (x, y), the corrected image can be determined by using a coordinate transformation formula that transforms the coordinates (u, v) of a distortion-free rectangular projected image into the coordinates (x, y) on the display element.

FIG. 1 is a diagram showing the positions of corrected pixels of a corrected image with a vertical trapezoidal distortion laid over the positions of pixels on the display element.

In the drawing, a mark ‘∘’ indicates a pixel position on the display element, and a mark ‘x’ indicates the position of the corrected pixel in the corrected image that is determined using the coordinate transformation formula for correcting vertical trapezoidal distortion. In reality, the image on the display element is projected on the projection surface upside down because the image is projected via a projecting lens. However, to simplify the description, the illustration is given such that both the top of the image on the projection surface and the top of the corrected image are located on the upper side.

In the projector that determines the corrected image using the coordinate transformation formula, when a certain pixel position (u0, v0) on the coordinate system (u, v) is transformed to a corrected pixel position (x0, y0), the values of x0 and y0 usually take real numbers.

However, since the pixels on the display element only exist at points with integer coordinates, the pixel value of the corrected image is corrected depending on the position of the pixel on the display element. Here, the pixel value is a value that indicates the color of each pixel represented by R(red), G(green) and B(blue).

Accordingly, in the projector, the pixel position (x0′, y0′) on the display element that is the closest to corrected pixel position (x0, y0) is selected, and the coordinate position (u0′, v0′) corresponding to the pixel position (x0′, y0′) on the projection surface is determined using the inverse transformation formula.

Then, the pixel value at (u0′, u0′) is interpolated using the pixel data on surrounding pixels existing around the coordinate position (u0′, v0′). The pixel value that is thus interpolated is used as the interpolated pixel value of the pixel (x0′, y0′) of the corrected image. These procedures are implemented for every pixel to thereby determine the corrected image.

Therefore, in order to determine a corrected image, it is necessary not only to handle the coordinate transformation formula and inverse transformation formula but also perform interpolation of the pixel values in the corrected image. As an interpolation technique for pixel values, for example, bilinear interpolation and bicubic interpolation can be listed.

The bilinear interpolation is a technique in which, each of the surrounding 2×2 pixels of the interpolated pixel, that are present in the vertical direction and in the horizontal direction, is weighted in accordance with the distance from the surrounding pixel to the interpolated pixel, and the weighted average of the thus weighted pixel values is used as the interpolated pixel value.

The bicubic interpolation is a technique in which, the pixel values of surrounding 4×4 pixels that are present in the vertical direction and in the horizontal direction are put into a non-linear function to determine the interpolated pixel value. Though the amount of computation increases because the interpolated pixel value is calculated from the pixel values of surrounding 4×4 pixels, the bicubic interpolation has an advantage in which the quality of the projected image is improved compared to that of the bilinear interpolation.

Patent Document 3 discloses a projector that determines interpolated pixel values in each pixel region on the corrected image, based on the area ratio of each pixel in the input image signal. In this projector, for every pixel on the display panel, the coordinates at the four corners of the pixel are determined, and based on the coordinates at the four corners, the correspondence between the displayed pixel and the dot position indicated by the input image signal is determined.

The position on the display panel corresponding to each dot indicated by the input image signal is determined from the pitch that is obtained by dividing the width of the display area by the number of dots in the horizontal and the pitch that is obtained by dividing the height of the display area by the number of dots in the vertical direction.

Thereby, in each of the pixels on the display panel, a divided area is created based on the position of each dot indicated by the input image signal, and the area ratio of each created divided area to the area of the entire pixel is calculated. Each pixel value indicated in the input image signal, corresponding to each divided area is weighted based on the area ratio of the divided area, and the weighted pixel values are combined so as to obtain an interpolated pixel value.

### RELATED ART DOCUMENTS

### Patent Document

Patent Document 1: JP2001-69433A

Patent Document 2: JP2002-14611A

Patent Document 3: JP2003-153133A

### SUMMARY OF THE INVENTION

### Problems to be Solved by the Invention

The general practice for projectors that carry out a process to correct geometric distortion is that multiple pixels that constitute an image are each treated as a point in the coordinate transformation of the image, and only the position coordinates of the center of each pixel is coordinate transformed. Further, also when the values of interpolated pixels of the corrected image are determined, each pixel is handled as a point (Patent Document 1 and Patent Document 2).

In Patent Document 3, in the region in each pixel in the corrected image, a divided area is set up in accordance with the position of each dot indicated by the input image signal, and the interpolated pixel value is determined based on the area ratios of the set divided areas. However, in a projection surface yielding geometric distortion, the shape of the projected pixel deforms into a form that can be no longer called a rectangle. Further, the shapes of pixels are changed in the corrected image deformed in accordance with geometric distortion.

Therefore, the greater the change to the shape of each pixel in the corrected image, the greater is the change to the area ratio of each pixel of the input image included in the pixel of the corrected image. Accordingly, the interpolated pixel value lowers in precision.

Thus, in the projected image when the corrected image is projected on a curved screen or in the upper part or the like of the projected image when the corrected image is upwardly tilt-projected, the shape of the pixels on the projected image greatly change, so that the precision of the pixel values of the corrected image becomes lower. As a result, there has been the problem in which the image quality of the projected images in degraded.

The object of the present invention is to provide an image processing apparatus and an image processing method that correct the image in response to distortion of the shape of pixels on a projection surface.

### Means for Solving the Problems

An image processing apparatus of the present invention includes: a display element having a plurality of pixels to display an image based on image data; a projection optical system projecting the image displayed on the display element onto a projection surface; a transforming means that, when receiving a correction parameter for changing the shape of the projected image in order to correct distortion of the projected image, performs coordinate transformation of each pixel of a source image represented by the image data, using the correction parameter, and outputs the result of coordinate transformation, which provides the coordinates of each pixel of the resultant output image that corresponds to the coordinates of each pixel of the source image; and, a processing means that determines the pixel value of every pixel of the output image in accordance with the ratio of the pixels of the source image in each pixel of the output image represented by the result of coordinate transformation.

An image processing method of the present invention is an image processing method performed by an image processing apparatus including a display element that has a plurality of pixels to display an image based on image data and a projection optical system that projects the image displayed on the display element onto a projection surface, and comprises the steps of: in response to reception of a correction parameter for changing the shape of the projected image in order to correct distortion of the projected image, performing coordinate transformation of each pixel of a source image represented by the image data, using the correction parameter, and outputting the result of coordinate transformation, which provides the coordinates of each pixel of the resultant output image that corresponds to the coordinates of each pixel of the source image; and, determining the pixel value of every pixel of the output image in accordance with the ratio of the pixels of the source image in each pixel of the output image represented by the result of coordinate transformation.

### Effect of the Invention

According to the present invention, it is possible to correct an image in response to a distortion of the shape of pixels on a projection surface.

### BRIEF DESCRIPTION OF THE DRAWINGS

FIG. 1 A diagram showing pixel positions on a display element and pixel positions on a corrected image with vertical trapezoidal distortion.

FIG. 2 A block diagram showing a configuration of an image display apparatus of the first exemplary embodiment of the present invention.

FIG. 3j A flow chart showing an example of procedural steps in an image processing method.

FIG. 4a A diagram showing one example of a source image represented by image data.

FIG. 4b A diagram showing a corrected image with vertical trapezoidal distortion on a display element.

FIG. 4c A diagram for illustrating how to determine an interpolated pixel value.

FIG. 4d A diagram showing a corrected image determined by the result of computation of interpolated pixel values.

FIG. 5 A diagram showing area ratio of the region of each corrected pixel overlapping an interpolated pixel.

FIG. 6 A diagram showing an overlapping area between a pixel on a display element and a corrected pixel.

FIG. 7 A diagram for illustrating the operation of an image display apparatus of the second exemplary embodiment.

### MODES FOR CARRYING OUT THE INVENTION

Next, each exemplary embodiment of the present invention will be described with reference to the drawings.

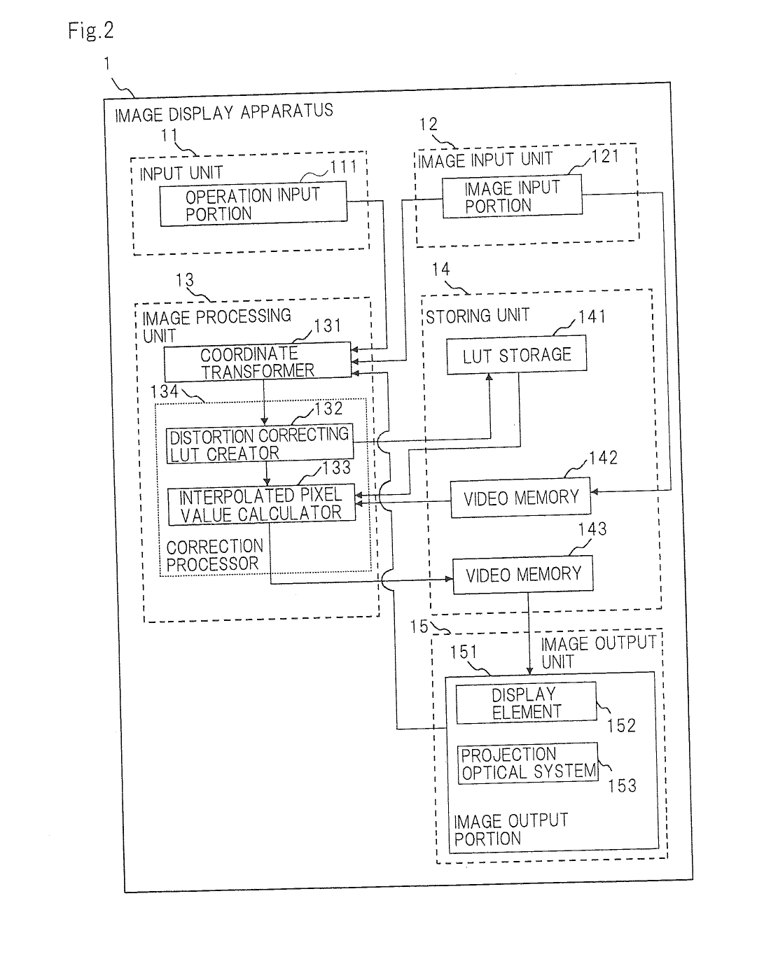

FIG. 2 is a block diagram showing a configuration of an image display apparatus in the first exemplary embodiment.

Image display apparatus 1 has a correcting function of correcting geometric distortion arising on a projection surface. Image display apparatus 1 is realized by a projector, for instance.

Image display apparatus 1 includes input unit 11, image input unit 12, image processing unit 13, storing unit 14 and image output unit 15. Image processing apparatus 13 includes coordinate transformer 131 and correction processor 134. Correction processor 134 includes distortion correcting LUT (Look Up Table) creator 132 and interpolated pixel value calculator 133.

Storing unit 14 may be generally called storing means.

Storing unit 14 includes LUT storage 141, video memory 142 and video memory 143.

LUT storage 141 stores a correction LUT for determining an image that corrects geometric distortion that would arise on the projection surface.

Video memory 142 retains image data representing the source image.

Video memory 143 retains output image data representing an output image.

Image output unit 15 outputs the image represented by the output image data stored in video memory 143. Image output unit 15 provides, for example the resolution of the output image to coordinate transformer 131. Image output portion 151 includes display element 152 and projection optical system 153. Display element 152 has a plurality of pixels to display an image. Projection optical system 153 projects the image displayed on display element 152 onto a projection surface. Hereinbelow, the image projected on a projection surface will be referred to as a projected image.

Image input unit 12 receives image data from image supplying device such as a PC (personal computer), for example. Image input unit 12 includes image input portion 121. When receiving image data, image input portion 121 acquires the resolution of the source image represented by the image data and supplies the resolution to coordinate transformer 131. Upon receiving the image data, image input portion 121 also records the image data into video memory 142.

Input to input unit 11 is a correcting parameter for changing the shape of the projected image in order to correct the distortion of the projected image. Input unit 11 includes operation input portion 111.

Upon receiving the correcting parameter input by user operation, operation input portion 111 supplies the correcting parameter to coordinate transformer 131. Operation input portion 111 accepts the correcting parameter designated by the user by means of a pointing device such as a slide bar, a numeric value input button, a mouse or the like.

For example, depending on the type of the geometric distortion of the projected image, operation input portion 111 receives a correcting parameter for the type. Examples of the types of geometric distortion include horizontal or vertical trapezoidal distortion, linear distortion in the horizontal or vertical direction, pincushion (spool) distortion, barrel distortion, bow-like distortion and the like.

Horizontal trapezoidal distortion and linear distortion in the horizontal direction arise when tilt projection in a horizontal direction relative to the flat screen is performed. Vertical trapezoidal distortion and linear distortion in the vertical direction arise when tilt projection in a vertical direction relative to the flat screen is performed. Pincushion distortion and barrel distortion occur when an image is projected onto a curved screen. When an image is obliquely projected on a curved screen, a bow-like distortion further arises.

For this reason, operation input portion 111 has a plurality of correcting parameters prepared for each type of geometric distortion and accepts correcting parameters designated through the slide bar and numeric value input button, from the plural correcting parameters.

Further, operation input portion 111 receives, as correcting parameters, four coordinate positions of the corners of the projection surface designated by a pointing device so that the projected image, after correction of geometric distortion, will become a rectangle when viewed from the user's viewpoint. In this case, if there is a mark on the projected position on the screen, designation of the coordinate positions can be easily done. Further, without regarding the shape of the screen, four corners can be designated so that the screen will become approximately rectangular when viewed from the user's view point, thus realizing easy designation of coordinate positions.

Alternately, operation input portion 111 may accept correcting parameters disclosed in Patent Documents 1 to 3. The shape of the screen, the vertical tilt angle and horizontal tilt angle with the projection surface, the distance from the projection surface to the projector, the magnifying power of the projecting lens and other numeric values can be accepted as the correcting parameters. Since the numerical values of correcting parameters are known beforehand, all it takes is simple entry of these values, which is convenient. However, it is difficult to measure the numeric values of these parameters with precision when the projector is set up. Further, adjustment using a slide bar and the like requires experience and skill.

Coordinate transformer 131 can be generally called a transforming means.

Coordinate transformer 131 receives correcting parameters from operation input portion 111. When receiving the resolution of the source image from image input portion 121, coordinate transformer 131 also receives the resolution of the output image from image output portion 151.

Coordinate transformer 131 performs a geometric coordinate transforming process using the resolution of the source image, the resolution of the output image and correcting parameters.

Specifically, when receiving correcting parameters, coordinate transformer 131 performs coordinate transformation of every pixel of the source image, specified by the resolution of the source image, using the resolution of the output image and the correcting parameters. Coordinate transformer 131 outputs the result of coordinate transformation, which provides the coordinates of each pixel of the resultant output image that correspond to the coordinates of each pixel of the source image, to distortion correcting LUT creator 132.

For example, coordinate transformer 131 determines the coordinate transformation formula using the correcting parameters, and performs coordinate transformation of the coordinate positions at four corners that specify the position and shape of each pixel on the source image, based on the determined coordinate formula. In the present exemplary embodiment, each pixel of the source image after coordinate transformation may also be called a corrected pixel of the corrected image.

Correction processor 134 can be, in general, called a processing means.

After receiving the result of coordinate transformation from coordinate transformer 131, correction processor 134 determines the pixel value of each pixel on the output image, in accordance with the ratio of the pixels of the source image in the pixel of the output image represented by the result of coordinate transformation. Here, the pixel value is the image data that represents the color of each pixel represented by R(red), G(green) and B(blue) color components. When the source image is white, the RGB image data all take the same value. When the source image is color, the same process is carried out for each of RGB colors in every pixel.

Distortion correcting LUT creator 132, after receiving the result of coordinate transformation from coordinate transformer 131, determines, for every pixel of the output image, the area ratio of each pixel of the source image overlapping the pixel of the output image, as a ratio of the pixel of the source image, by reference to the result of coordinate transformation.

Then, distortion correcting LUT creator 132 calculates the operational coefficients depending on the area ratio of each pixel of the source image given by the result of coordinate transformation. For example, distortion correcting LUT creator 132, referring to the result of coordinate transformation, determines the area of the overlapping region where the pixel of the output image and the pixel of the source image overlap, and calculates the ratio of the overlapping region to the total region of the pixel of the output image. Distortion correcting LUT creator 132 records the operational coefficients into the correction LUT inside LUT storage 141. Accordingly, the operational coefficients for each pixel of the source image in each pixel of the output image presented by the result of coordinate transformation is stored in LUT storage 141.

Interpolated pixel value calculator 133 can be generally called a determining means.

Interpolated pixel value calculator 133, when reading the image data out of video memory 142, also reads the correction LUT from LUT storage 141. Interpolated pixel value calculator 133 determines the pixel value (which will be also called interpolated pixel value) using the operational coefficient of each pixel of the source image represented by the correction LUT and the pixel value of each pixel of the source image represented by the image data.

Interpolated pixel value calculator 133 records the output image data representing the thus determined, interpolated pixel value of every pixel into video memory 143. This process of determining the interpolated pixel value may be performed by either software or hardware.

Image output portion 151 displays the image represented by the output image data stored in video memory 143. Image output portion 151 includes, for example, a light source for emitting light, display element 152 for modulating the light emitted from the light source in accordance with the output image data and projection optical system 153 including a projecting lens and others.

Image output portion 151, after reading output image data from video memory 143, displays the output image whose shape is changed by geometric distortion correction, i.e., the image based on the image data representing the source image, on display element 152. Then image output portion 151 projects the image displayed on display element 152 onto the projection surface by way of projection optical system 153.

Though the present exemplary embodiment was described taking an example in which image processing unit 13 is provided for image display apparatus 1, image processing unit 13 may be provided inside the image supplying apparatus such as a personal computer or the like.

Further, though the present exemplary embodiment was described referring to a configuration where image display apparatus 1 includes input unit 11, image input unit 12 and storing unit 14, the present invention may be configured only by coordinate transformer 131, correction processor 134 and image output unit 15. The apparatus configured by coordinate transformer 131, correction processor 134 and image output unit 15 only may be generally called an image processing apparatus.

Next, the operation of image display apparatus 1 will be described in detail.

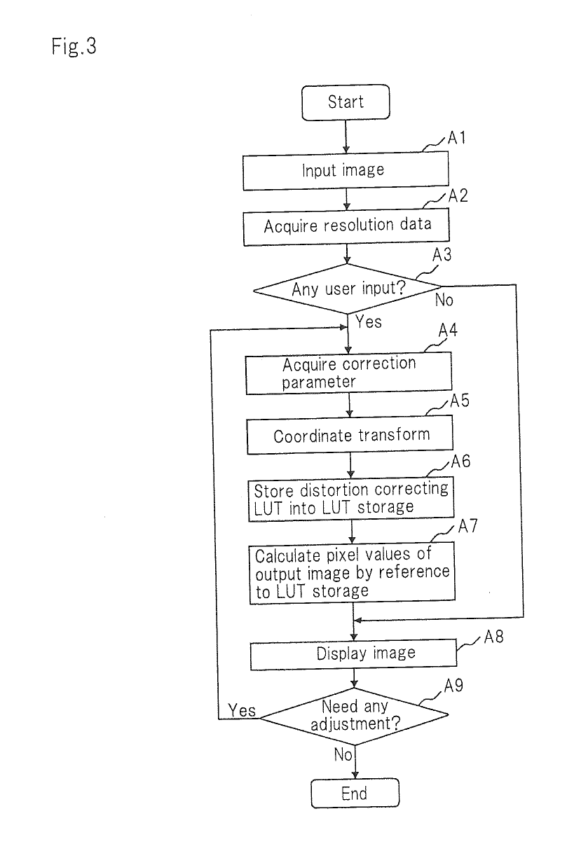

FIG. 3 is a flow chart showing an example of processing steps of the image processing method.

When receiving image data representing a source image, image input portion 121 records the image data into video memory 142 (Step A1).

Coordinate transformer 131 acquires the resolution of the source image represented by the image data (Step A2). Then, after receiving correction parameters input through operation input portion 111 by user operation (Steps A3 and A4), coordinate transformer 131 determines the coordinate transformation formula using the correction parameters.

Then, coordinate transformer 131 performs coordinate transformation of the position and shape of every pixel of the source image specified by the resolution of the source image, by using the coordinate transformation formula, to determine the coordinates of each coordinate-transformed pixel of the source image. Coordinate transformer 131 supplies the result of coordinate transformation, which provides the coordinates of each pixel of the resultant output image that correspond to the coordinates of each pixel specified by the resolution of the output image, to distortion correcting LUT creator 132 (Step A5).

After receiving the result of coordinate transformation from coordinate transformer 131, distortion correcting LUT creator 132 calculates operational coefficients for each pixel of the output image in accordance with the area ratio of the pixels of the source image represented by the result of coordinate transformation. Distortion correcting LUT creator 132 records the operational coefficient for every pixel of the source image in each pixel of the output image, in a form of correction LUT (Step A6).

Thereafter, interpolated pixel value calculator 133 reads out the image data representing the source image from video memory 142, and determines interpolated pixel values for every pixel, using the operational coefficients for the pixels of the source image given in the correction LUT from LUT storage 141 and the pixel values of the pixels of the source image represented by the image data (Step A7). Interpolated pixel value calculator 133 calculates the interpolated pixel values for every pixel of the output image and records the output image data into video memory 143.

Image output portion 151 reads out the output image data from video memory 143 and displays the image represented by the output image data on the display element and projects the image onto the projection surface by way of the projection optical system (Step A8).

Thereafter, if the projected image needs to be further adjusted to correct for geometric distortion and when operation input portion 111 receives correction parameters (Step A9), the control returns to Step A4. Steps A4 to A8 is repeated until the adjustment work of geometric distortion is completed. When the adjustment work of geometric distortion is completed, the processing procedure of the image processing method ends.

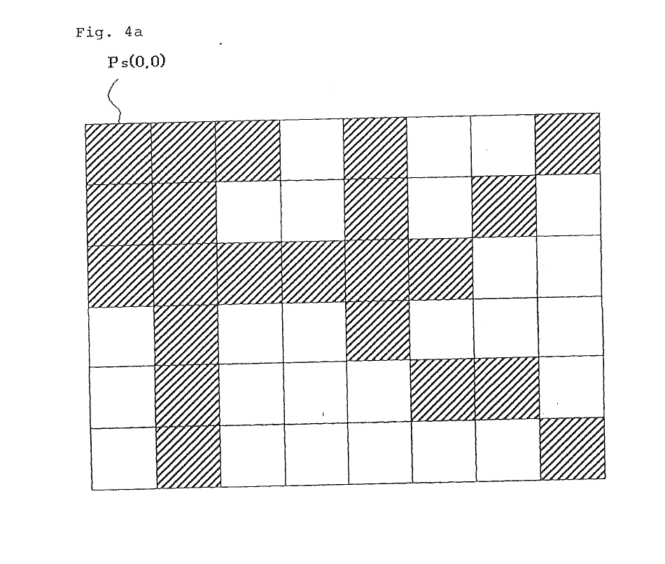

Next, the operations of coordinate transformer 131, distortion correcting LUT creator 132 and interpolated pixel value calculator 133 will be described with reference to FIGS. 4a to 4d. In this case, it is assumed that image display apparatus 1 performs a process of correcting vertical trapezoidal distortion on the image data when the image is tilt-projected in the vertical direction relative to the projection surface.

FIG. 4a is a diagram showing one example of a source image represented by image data. Herein, to make description simple, the source image having a resolution of 8×6 pixels is shown. Each pixel is denoted by Ps (i, j), and the pixel value of each pixel is denoted by Cs (i, j).

The blank part in the drawing has a pixel value of ‘0’, whereas the hatched part has a pixel value of ‘255’. When the pixel value is ‘0’, black is displayed. When the pixel value is ‘255’, white is displayed. For example, the top left pixel Ps (0,0) in the drawing has pixel value Cs (0,0) of ‘255’.

Coordinate transformer 131 performs coordinate transformation of each pixel of the source image shown in FIG. 4a in accordance with the correction parameters. In FIGS. 4b to 4d, a pixel of the source image that has been coordinate transformed is called a corrected pixel of a corrected image.

FIG. 4b is a diagram showing a corrected image with vertical trapezoidal distortion on the display element.

In FIG. 4b, each corrected pixel Ps (i, j) of the corrected image is shown. The display element is formed of square pixels shown by broken line. Each pixel of the output image on the display element is denoted by Pd (i, j), and the pixel value is denoted by Cd (i, j).

Here, in the display element, the center of each pixel is only present on integer coordinates and the shape of the pixel is fixed, so that it is, in practice, impossible to reproduce the corrected image shown in FIG. 4b on the display element.

Now, how interpolated pixel value Cd (5, 2) of pixel Pd (5, 2) enclosed by thick broken line is determined will be described.

FIG. 4c is an enlarged diagram of pixel Pd (5, 2) shown in FIG. 4b.

Pixel Pd (5, 2) on the display element overlaps four corrected pixels, namely corrected pixel Ps (5, 1), corrected pixel Ps (6, 1), corrected pixel Ps (5, 2) and corrected pixel Ps (6, 2).

Distortion correcting LUT creator 132 determines the area of the overlapping region where the corrected image region showing the region of the corrected pixels and pixel Pd (5, 2) overlap, for each of corrected pixel Ps (5, 1), corrected pixel Ps (6, 1), corrected pixel Ps (5, 2) and corrected pixel Ps (6, 2).

Then, distortion correcting LUT creator 132 calculates the area ratio of the overlapping region in each of corrected pixel Ps (5, 1), corrected pixel Ps (6, 1), corrected pixel Ps (5, 2) and corrected pixel Ps (6, 2). Here, the area ratio of the overlapping region means the ratio of the overlapping region occupying the area of the display region of one pixel.

Distortion correcting LUT creator 132 stores the area ratio of each of the corrected pixels included in pixel Pd (5, 2) that corresponds to the positional information of the pixel that specifies the position of pixel Pd (5, 2) into the correction LUT in LUT storage 141.

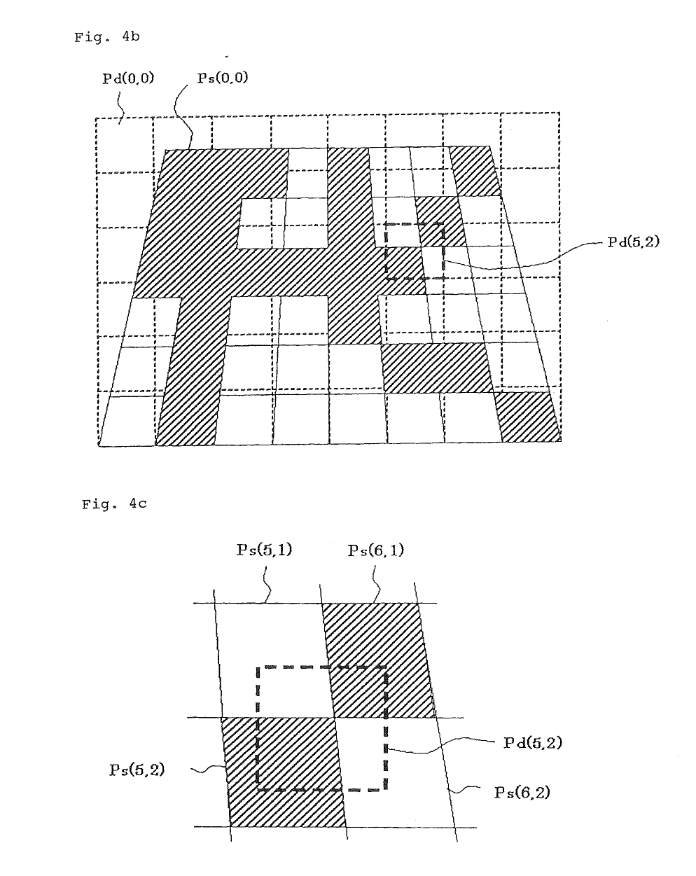

FIG. 5 is a diagram showing the calculation result of the area ratio of each of the corrected pixels overlapping pixel Pd (5, 2).

The corrected pixels overlapping pixel Pd (5, 2) are Ps (5, 1), Ps (6, 1), Ps (5, 2) and Ps (6, 2), and the area ratios of corrected pixels Ps (5, 1), Ps (6, 1), Ps (5, 2) and Ps (6, 2) are 22%, 16%, 44% and 18%, respectively.

In the above way, distortion correcting LUT creator 132 determines the area ratio of every corrected pixel included in the display region of each pixel of all pixels Pd (0,0) to Pd (7, 5), and stores the area ratio of each pixel that corresponds to the positional information of the pixel into the correction LUT.

Interpolated pixel value calculator 133 determines pixel values Cd (i, j) on the display element, i.e., the interpolated pixel values of the output image, using the correction LUT and pixel values Cs (i, j) of the source image.

For example, in pixel Pd (5, 2), pixel Cs (5, 1)=0, pixel Cs (6, 1)=255, pixel Cs (5, 2)=255 and pixel Cs (6, 2)=0, so that interpolated pixel value Cd (5, 2) can be determined by the following equation.

Cd(5,2)

=Cs(5,1)×0.22+Cs(6,1)×0.16+Cs(5,2)×0.44+Cs(6,2)×0.18

=0×0.22+255×0.16+255×0.44+0×0.18

=153.

FIG. 4d is a schematic diagram showing the output image determined by the result of computation of interpolated pixel values Cd (0,0) to Cd (7, 5).

Now, how to determine the overlapping region between the pixel on the display element and the corrected pixel will be described in detail.

Since the region that has the corrected pixel is a quadrilateral other than a square, the overlapping region between the corrected pixel and the pixel on the display element takes a polygonal form having three to eight sides. Generally, to determine the area of a polygon, the polygon is divided into triangles, and the area of each of the divided triangles is calculated using Heron's formula, and the areas of these triangles are added up.

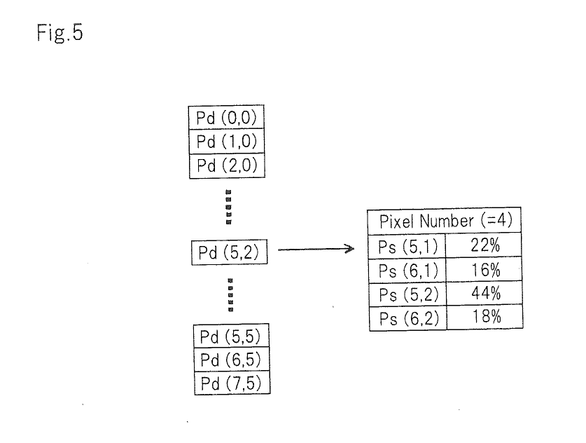

FIG. 6 is a diagram showing one example of an overlapping region in which pixel 20 on the display element and corrected pixel 30 overlap. In the example of FIG. 6, the overlapping region between pixel 20 and corrected pixel 30 is a pentagon.

The positions of vertexes 31 to 34 at four corners of the corrected pixel that specifies the region of corrected pixel 30 can be determined by executing the same process so as to perform coordinate transformation of the position of the center of the pixel.

For example, when the coordinate position of the center of a pixel on the source image is denoted as (X, Y), the positions of the four vertexes of the pixel that specify the shape of the pixel on the source image are given as (X−0.5, Y−0.5), (X−0.5, Y+0.5), (X+0.5, Y−0.5) and (X+0.5, Y+0.5), whereby coordinate transformer 131 coordinate transforms the positions of the four vertexes of the pixel in accordance with the correcting parameters so as to determine the positions of four vertexes of the corrected pixel. The positions of the four vertexes of the corrected pixel represent the shape of the corrected pixel.

The coordinates position of intersection point 24 between pixel 20 and pixel 30 can be determined as a point of intersection where the straight line joining vertex 32 of the corrected pixel and vertex 33 of the corrected pixel cuts the bottom side of pixel 20. Similarly, the coordinates position of intersection point 26 between pixel 20 and pixel 30 can be determined as a point of intersection where the straight line joining vertex 31 of the corrected pixel and vertex 34 of the corrected pixel cuts the right side of pixel 20. Since pixel 20 resides on the display element, pixel vertex 25 that specifies the display region of pixel 20 is obvious.

In this way, distortion correcting LUT creator 132 determines coordinate positions 24, 25, 26, 31 and 32 of the five vertexes of the pentagonal overlapping region where pixel 20 and corrected pixel 30 overlap.

Herein, when vertex 31 of the corrected pixel and intersection point 24, as well as vertex 31 of the corrected pixel and intersection point 25, are joined by a straight line, the pentagonal overlapping region is divided into triangle 21, triangle 22 and triangle 23. For each of triangles 21, 22 and 23, the coordinate positions of the vertexes of each triangle is already-known, the lengths of three sides of the triangle can be determined. Accordingly, use of Heron's formula can give the areas of triangles 21, 22 and 23, and these areas are summed up to provide the area of the polygonal overlapping region.

Thereby, distortion correcting LUT creator 132 divides the corrected pixel area into triangular regions, by use of corrected coordinate positions 31 and 32 included in the display region of pixel 20 and coordinate positions 24, 25 and 26 that specifies the display region of pixel 20. Distortion correcting LUT creator 132 calculates the area of each of the divided triangular regions.

Distortion correcting LUT creator 132 performs the same process as above for the other corrected pixels included in the display region of pixel 20, and determines the area ratio of the overlapping region of each corrected pixel that overlaps the display region of pixel 20, and stores the area ratio that corresponds to the pixel positional information of pixel 20 into the correction LUT in LUT storage 141.

After receiving the image data, interpolated pixel value calculator 133 calculates the interpolated pixel values of the output image by reference to the correction LUT. Therefore, even if the source image changes with time as in a case of motion picture, interpolated pixel value calculator 133 can easily determine the interpolated pixel values of the corrected image by product-sum operation using the pixel values of the new source image and the correction LUT.

Here, in a stage of adjustment in which the user conducts operations for adjusting distortion of the projected image by operating operation input portion 111, it is preferable that every time image display apparatus 1 receives correction parameters from operation input portion 111, the apparatus computes a corrected image in accordance with the numeric values of the corrected parameters and displays the corrected image. In this case, in the adjustment stage, image display apparatus 1 may use bilinear interpolation or the like, which needs less time for computing interpolated pixel values, to determine the corrected image, and then once again determine the corrected image using the correction LUT after completing adjustment. This enables quick adjustment of geometric distortion while preventing degradation of image quality of the projected image.

According to the first exemplary embodiment of the present invention, in image display apparatus 1 including display element 152 that has a plurality of pixels to display an image based on image data and projection optical system 153 that projects the image displayed on display element 152 onto a projection surface, coordinate transformer 131, after receiving a correction parameter, performs coordinate transformation of each pixel of the source image represented by the image data, that corresponds to the correction parameter. Coordinate transformer 131 outputs the result of coordinate transformation, which provides the coordinates of each pixel of the resultant output image that corresponds to the coordinates of each pixel of the source image. Correction processor 134, after receiving the result of coordinate transformation, determines the pixel value of every pixel of the output image in accordance with the ratio of the pixels of the source image in each pixel of the output image represented by the result of coordinate transformation.

In the projector disclosed in Patent Document 3, rectangularly divided areas are configured in each pixel of the corrected image, each being formed in accordance with the positions of the dots presented by the input image signal, and interpolated pixel values are determined based on the area ratio of the setup divided areas.

However, on the projection surface producing geometric distortion, the shape of the projected pixels changes and takes a form that cannot be said to be a rectangle. For example, as shown in FIG. 4b, when the corrected image is upwardly tilt-projected, in the upper part of the display element shown by the broken line, the pixels of the corrected image represented by the solid line greatly vary in shape, and become smaller in area.

Accordingly, even if the position of each pixel of the input image in each pixel of the corrected image is the same, the area ratio of each pixel of the input image varies as the change in shape of each pixel of the input image becomes greater, so that the accuracy of interpolated pixel values is degraded.

In contrast to this, image display apparatus 1 corrects the image by determining interpolated pixel values of the output image in accordance with the distortion in the pixel region on the projection surface. As a result, it is possible to determine the interpolated pixel values with high accuracy, so that it is possible to inhibit degradation of the projected image.

Further, in the present exemplary embodiment, image display apparatus 1 includes LUT storage 141 for storing the ratio of the pixels of the source image in each pixel of the output image, and interpolated pixel value calculator 133, after receiving image data, determines the pixel value for every pixel of the output image, based on the ratio of the pixels in the source image stored in LUT storage 141 and on the pixel values of the source image represented by the image data.

Accordingly, because image display apparatus 1 does not need to calculate the area ratio of each pixel of the source image that has been coordinate transformed every time image data arrives, it is possible to reduce the amount of computational processing for interpolated pixel values.

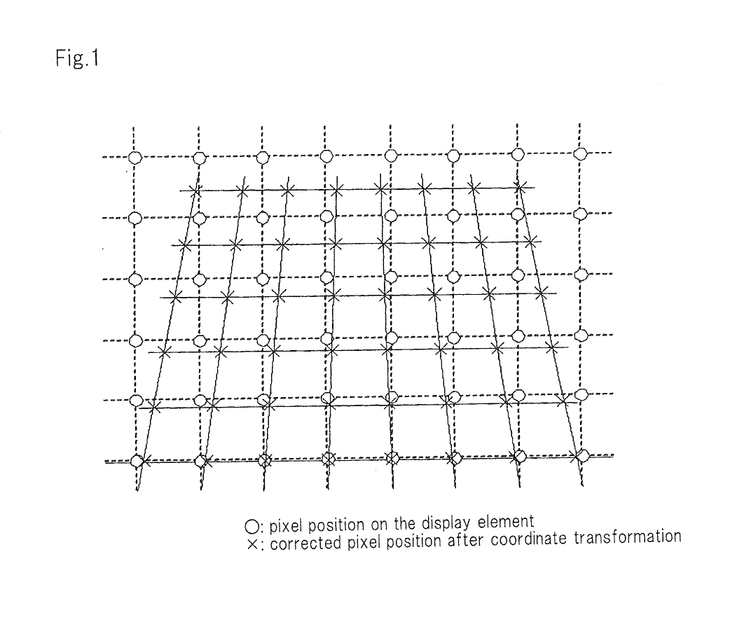

Next, the image display apparatus in the second exemplary embodiment will be described. The image display apparatus of the present exemplary embodiment basically has the same configuration as image display apparatus 1 shown in FIG. 1. This exemplary embodiment uses a different method from that of the first exemplary embodiment to determine the area of the overlapping region where the pixel on the display element and the corrected pixel overlap.

In the second exemplary embodiment, a plurality of divided areas or N×N equally divided small regions are configured in the pixel on the display element. Distortion correcting LUT creator 132 determines whether or not the coordinate position of the center of each of the thus divided areas resides in the corrected pixel region for every corrected pixel. Distortion correcting LUT creator 132 counts the number of divided areas occupied by each corrected pixel, from among the plurality of divided areas, and calculates the area ratio from the number of areas in each corrected pixel.

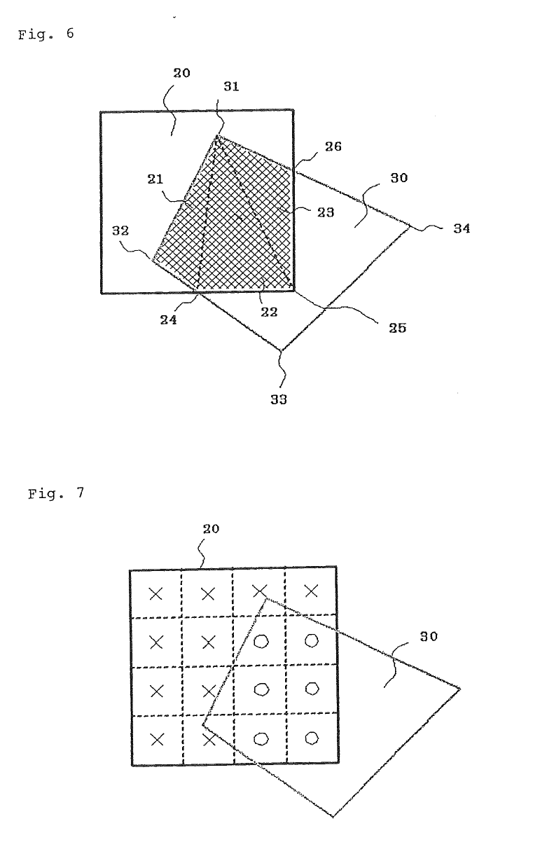

FIG. 7 is a diagram for illustrating how to determine the area of the overlapping region in the second exemplary embodiment. In FIG. 7, pixel 20 of the output image on the display element, corrected pixel 30 and 4×4 divided areas into which the display region of pixel 20 is divided are shown. The smallest squared display region enclosed by the broken line corresponds to one divided area.

The mark ‘x’ in the drawing indicates that the coordinate position of the center of the divided area is not included in corrected pixel 30, whereas the mark ‘∘’ indicates that the coordinate position of the center of the divided area is included in corrected pixel 30.

In FIG. 7, the number of mark ‘∘’ is six, so that the area ratio of the overlapping region between pixel 20 and pixel 30 is 1/16.

According to the second exemplary embodiment, distortion correcting LUT creator 132 determines the ratio of the area of the pixel of the corrected image as the number of divided areas that are occupied by the pixel of the corrected image represented by the result of coordinate transformation, from among the multiple divided areas configured in each pixel of the output image.

Therefore, the scheme of the second exemplary embodiment can reduce the amount of computation for the area ratio of each corrected pixel, compared to the first exemplary embodiment in which the area ratio is determined by dividing the overlapping region between the pixel of the out image and the corrected pixel into triangles. As a result, it is possible to execute the process of computing interpolated pixel values of the output image at high speed.

Moreover, in order to enhance the accuracy of calculation of the area ratio of corrected pixels, the number of N×N divided areas may be increased. For example, if N is set with 2 to the power of n, area S of the pixel on the display element is equal to 2²ⁿ (S=(2ⁿ)²=2²ⁿ), and the denominator for the area ratio is 2²ⁿ. Accordingly, division of computation of interpolated pixel values can be performed by a bit-shift operation, so that computation of interpolated pixel values can be performed at high speed.

Though each of the exemplary embodiments was described by giving an example where the projection surface is flat, the present invention can be applied to a case where the projection surface is curved. For example, when the projection surface is spherical, it is possible to determine the corrected image by using the coordinate transformation formula disclosed in Patent Document 2. When the projection surface is cylindrical or the like, it is possible to obtain the coordinate transformation formula for determining the corrected image if the positional relationship between the projector and the projection surface, the projecting magnification of the projecting lens, geometric information such as the size of the projection surface and the radius of curvature are given.

In the exemplary embodiments described heretofore, the illustrated configurations are mere examples, and the present invention should not be limited by the configurations.

### DESCRIPTION OF REFERENCE NUMERALS

1 image display apparatus
11 input unit
12 image input unit
13 image processing unit
14 storing unit
15 image output unit
111 operation input portion
121 image input portion
131 coordinate transformer
132 distortion correcting LUT creator
133 interpolated pixel value calculator
134 correction processor
141 LUT storage
142, 143 video memory
151 image output portion
152 display element
153 projection optical system

1. An image processing apparatus comprising:
a display element having a plurality of pixels to display an image based on image data;
a projection optical system projecting the image displayed on the display element onto a projection surface;
a transforming means that, after receiving a correction parameter for changing the shape of the projected image in order to correct distortion of the projected image, performs coordinate transformation of each pixel of a source image represented by the image data, using the correction parameter, and outputs the result of coordinate transformation, which provides the coordinates of each pixel of the resultant output image that corresponds to the coordinates of each pixel of the source image; and,
a processing means that determines the pixel value of every pixel of the output image in accordance with the ratio of the pixels of the source image in each pixel of the output image represented by the result of coordinate transformation.

2. The image processing apparatus according to claim 1, further including a storing means storing the ratio of pixels in the source image in each pixel of the output image,
wherein the processing means, after receiving the image data, determines the pixel value for every pixel of the output image, based on the ratio of the pixels of the source image stored in the storing means and on the pixel values of the source image.

3. The image processing apparatus according to claim 1, wherein the processing means determines as the ratio the number of divided areas that are occupied by the pixel of the source image, from among the multiple divided areas configured in each pixel of the output image.

4. An image processing method performed by an image processing apparatus including a display element that has a plurality of pixels to display an image based on image data and a projection optical system that projects the image displayed on the display element onto a projection surface, comprising:
in response to receiving a correction parameter for changing the shape of the projected image in order to correct distortion of the projected image,
performing coordinate transformation of each pixel of a source image represented by the image data, using the correction parameter, and outputting the result of coordinate transformation, which provides the coordinates of each pixel of the resultant output image that corresponds to the coordinates of each pixel of the source image; and,
determining the pixel value of every pixel of the output image in accordance with the ratio of the pixels of the source image in each pixel of the output image represented by the result of coordinate transformation.

5. The image processing method according to claim 4, wherein determination of the pixel value includes:
storing the ratio of pixels of the source image in each pixel of the output image, into a storing means; and
in response to receiving the image data, determining the pixel value for each pixel of the output image, based on the ratio of pixels of the source image stored in the storing means and on the pixel values of the source image.
